(19) United States
(12) Patent Application Publication
(10) Pub. No.: US 2005/0126509 A1
(43) Pub. Date: Jun. 16, 2005

(54) Calming unit for animals

(76) Inventor: Emily Weiss, Benton, KS (US)

Correspondence Address: DILWORTH & BARRESE, LLP, 333 EARLE OVINGTON BLVD., UNIONDALE, NY, 11553, US

(21) Appl. No.: 10/732,096

(22) Filed: Dec. 10, 2003

(51) Int. Cl. A01K 15/00

(52) U.S. Cl. 119/712

(57) ABSTRACT

A portable calming unit for humanely restraining an aggressive animal is configured with a plurality of openings allowing the operator to administer a variety of procedures while reliably, yet harmlessly, restraining the animal.

### BACKGROUND OF THE INVENTION

1. Field of the Invention

This invention relates to pet restrictors, and more particularly pertains to calming devises or units configured to prevent animals from self-inflicting harm while being aided by an operator.

2. Description of the Prior Art

In the handling and care of animals, it is customary to have close contact with the animals. Originally, this contact was achieved by using nooses, tranquilizers and catch poles. Further development of a restraining device included a long pole with a snare called a catchpole. While still widely used, the catchpole may cause high levels of stress for the animal. Besides, the effective use of the catchpole is predicated on long hours of practice since as simple as the structure of the catchpole is, in reality, to properly catch the animal and further to contain it requires that the operator possess high levels of concentration and physical ability.

Later, chutes have been developed that are only slightly wider than the animal. By closing the chute in front and behind a fairly large animal, such as a horse or cow, it is possible to confine it in a space only slightly larger than its own size.

With an animal confined in the chute, the operator can approach the animal to administer the desirable procedure without fear of injury. Although most chutes originally were permanently constructed at a fixed location, portable chutes now are available that can be moved to the place where the animal is located.

Regardless of the restraining instrument, it is designed as a shield to protect the operator from an attack by the animal. The rationale behind the entire procedure is to tough the animal, not to calm it down. Exemplification of the protective shield is disclosed in U.S. Pat. No. 4,860,776 and includes an expanding top with a reinforced tip constructed to press against the animal. Restraining the animal with a point-configured shield may be psychologically and physically damaging to the animal.

Those working with laboratory animals and with animals going to slaughter have found that applying pressure to the whole body when needing to manipulate the animal can vastly decrease stress. These squeeze devices, operating similarly to the structure as disclosed in U.S. Pat. No. 4,991,543, can cost thousands of dollars and involve designing a facility with built in devices.

From the above discussion, it is clear that previous devices and methods for restraining animals have not provided desirable solutions in many situations. Some of the existing devices are designed without any regard to wellbeing of animals, whereas others are cost inefficient and complicated.

It is therefore desirable to have a structurally simple and cost-efficient calming device configured to prevent the animal from hurting itself, while allowing the operator to treat the animal he/she would otherwise not be able to treat.

### SUMMARY OF THE INVENTION

This objective is attained by a portable calming unit, which includes a panel configured to have a shape and dimensions to provide a full body contact with an animal, which may be, thus, gently forced towards the desired position. The calming unit allows the operator to both see an aggressive animal while gaining control over it, and to treat the animal once it has been restrained.

In accordance with one aspect of the invention, the panel is configured to have a discontinuous smooth outer surface provided with dimensions sufficient to protect an operator while gently pressing a large area of the smooth outer surface against the animal without hurting it. Discontinuity or perforation of the surface is realized by a plurality of spaced throughgoing openings strategically located to help the operator clearly see the animal as well as to form multiple access ports, through which the operator can administer necessary procedures.

In accordance with one aspect of the invention including the use of the calming unit in a cage or kennel, the panel is adjustable to conform to the inner surface of variously dimensioned cages. As a consequence, the calming unit can be, for example, expanded to fit a large kennel while both reliably shielding the operator and preventing the animal from escaping the kennel. To provide the operator with the maneuverability within the kennel, the calming unit has a means for holding mounted on the panel to help the operator easily rock the animal back into the wall of the cage and easily hold it there.

As can be understood based on the above disclosure, one of the advantages of the inventive calming unit is its simplicity and effectiveness, which translates into a cost-efficient and effective tool for humanely treating the animal. Still a further advantage of the inventive calming unit is its universal use with newly designed cages and kennel as well as with already existing ones.

In accordance with a further aspect of the invention, the inventive calming unit is configured for use with differently dimensioned cages or kennels. To make the calming unit particularly cost efficient, the panel can be expanded in horizontal and vertical planes to fit the interior of differently dimensioned cages and/or cages.

### BRIEF DESCRIPTION OF THE DRAWINGS

The above and other features, objects and advantages will become more readily apparent from the detailed description of the invention, accompanied with the following drawings, in which:

FIG. 1 is a perspective view of calming unit configured in accordance with one embodiment of the invention;

FIG. 1A is a perspective view of assembly including a standard cage or kennel and the calming unit of FIG. 1 of the invention;

FIG. 2 is an exploded view of the inventive calming unit as seen from the outer side thereof;

FIG. 3 is a cross-section of the inventive calming unit taken along lines III-III, as illustrated in FIG. 2;

FIG. 4 is a perspective view of the assembly of FIG. 2 configured in accordance with a further embodiment of the inventive calming unit; and

FIG. 5 is a calming panel configured in accordance with yet another embodiment of the present invention.

### DETAILED DESCRIPTION

According to the invention, as shown in FIG. 1, safe and humane handling of aggressive animals in shelter and pound settings is realized by a calming unit 100 configured to gain control over an animal while preventing it from hurting itself. The calming unit 100 includes a panel 10′ with a smooth outer side 16′ shaped and dimensioned to provide a large area of contact with the animal while observing it through a plurality of perforations 24′ traversing the panel 10′ between its inner side 18′ and outer side 16′. While the shape of the panel 10′ can vary from circular to oval to polygonal, it is invariably configured to a) establish the largest possible area with the animal, b) protect the animal from self inflicting harm, and c) protect the operator. Thus, the perforated panel 10′ provided with a pair of handles 20′ can be effectively operated to control and calm down the animal regardless of whether the encounter with the animal occurs on a street or in a relatively small and well defined area, such as a cage or kennel

Dimensionally, the inventive calming unit 100 can be made in all different sizes—small ones for cat cages, large ones for large dogs placed in kennels. Based on the variety of sizes, one of the aspects of the invention is concerned with a kit having a multiplicity of differently dimensioned panels 10′, each of which is configured to handle an animal of predetermined size. Furthermore, in addition to various sizes, the panels 10′ constituting the kit may be variously shaped, which, depending on material, can be realized by extrusion.

Turning to FIGS. 1A-3, illustrating the application of the calming unit in a shelter, it is presumed that an animal has been already placed in a kennel or cage 12. The operator, having stepped into the kennel, can displace a panel 10 towards a rear wall 14 of the kennel 12. The panel 10 allows the operator to both gain control of an animal while gently pushing it by the panel 10 until creating a space slightly larger than the animal and defined between a smooth outer side 16 (FIG. 2) of the panel and the wall 14.

By dimensioning the panel 10 so that the clearances between an outer peripheral edge 22 (FIG. 2) of the panel 10 and the inner surface of the cage 12 are so small that the animal cannot escape, displacement of the animal becomes a relatively simple and stress-avoiding task. To facilitate displacement of the panel 10, its smooth inner side 18 (FIG. 1A) is configured to support one or more handles 20 located so that the operator can balance the panel 10 in response to the inevitable resistance by the animal. Preferably, the handles 20 are positioned in the near center position to provide the operator the desirable maneuverability to manipulate the animal while administering various procedures that, otherwise, would be difficult to accomplish.

Upon placing the panel 10 within the cage 12, the operator is able to rock the animal towards the wall 14 while observing and treating the yielding animal through a plurality of holes 24 (FIGS. 2-3) traversing the panel 10. The holes each may be uniformly dimensioned and shaped to vary from circular to oval to polygonal, advantageously. Advantageously, however, the holes are conical with a relatively large diameter on either one of the outer and inner sides 16, 18 of the panel 10 and a relatively small diameter on the opposite side. Preferably, a relatively narrow diameter is formed on the outer side 16 to further localize the desire part of the animal's body for the desirable procedure, such as an injection. Furthermore, while the outer side 16′ of FIG. 1 is flat, the outer side 16 of the panel 10 of FIG. 1A is inwardly concave in at least one of horizontal and vertical planes. The curved outer side 16 may help the animal position itself in the middle of the panel 10, which, in turn, may facilitate the operator's job.

Cages and kennels are usually uniformly shaped but have different dimensions. Accordingly, to provide the calming unit 100 (FIG. 2) with the desirable universality, it is configured to have the panel 10 provided with an adjustable structure including formations 38. The latter are provided along at least two transversely extending sides 20 and 22 of the panel 10 and configured to selectively receive width- and height-modifying components 32, 34, respectively, to vary the width and height of the panel 10. To accomplish coupling between the panel 10 and width- and height-modifying components 32, 34, the latter are provided with formations 36 shaped and dimensioned complementary to the formations 38 of the panel 10. Given only as an example, the formations 36 and 38 may constitute a tongue and dovetail groove formation allowing the components 32, 34 and the panel 10 to engagingly slide relative to one another, as indicated by arrows S and S′. Relative displacement of one or more width-modifying components 32 as well as the height-modifying component 34 and the panel 10 allows all of these parts to be removably attached to one another. While the above disclosed structure is composed from separate elements, as a matter of design, the panel 10 and dimension-modifying components may be inseparable from but still displaceable relative to one another.

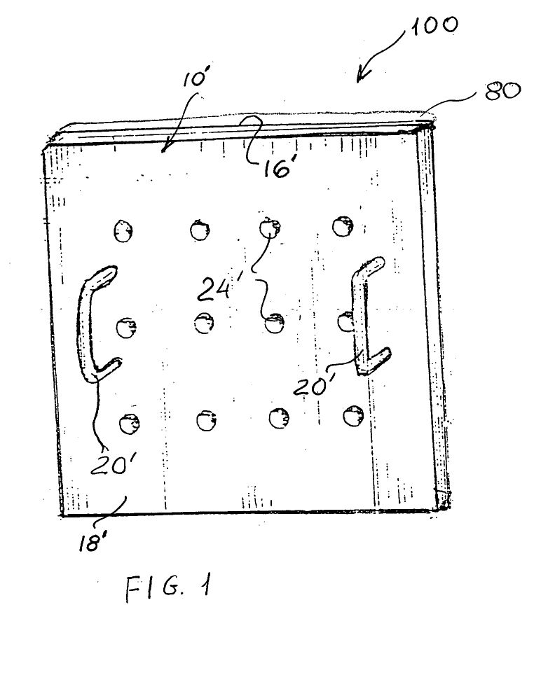

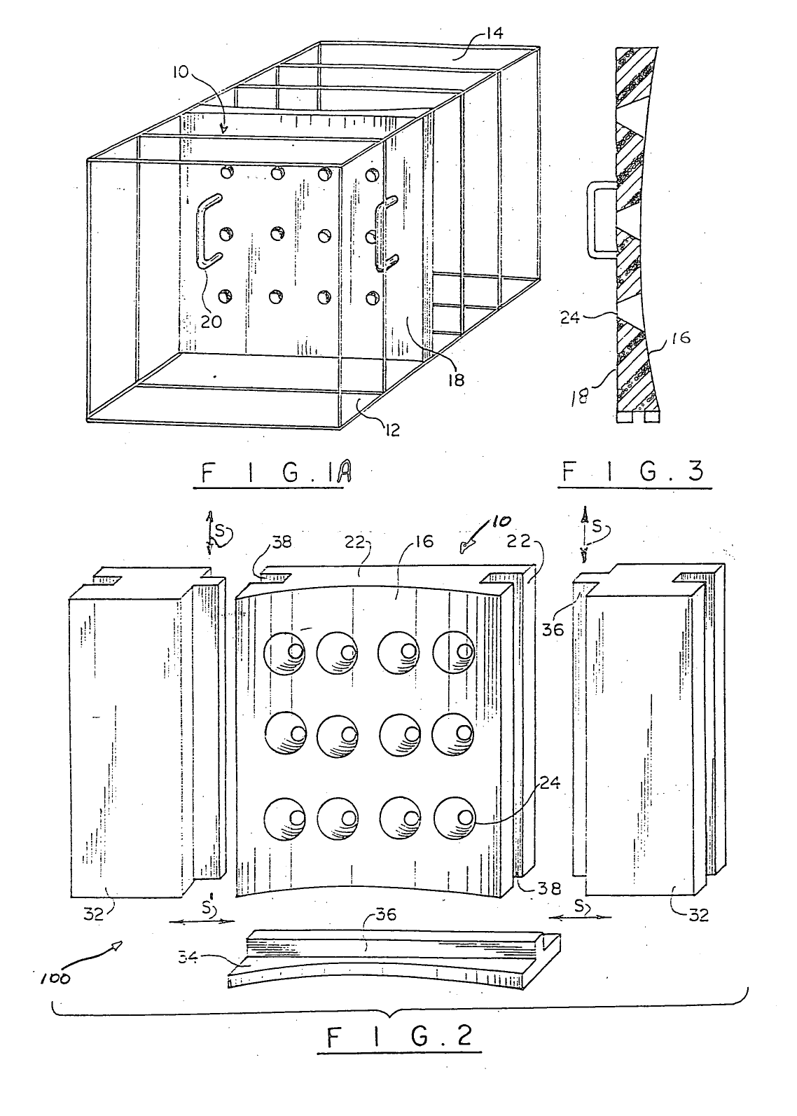

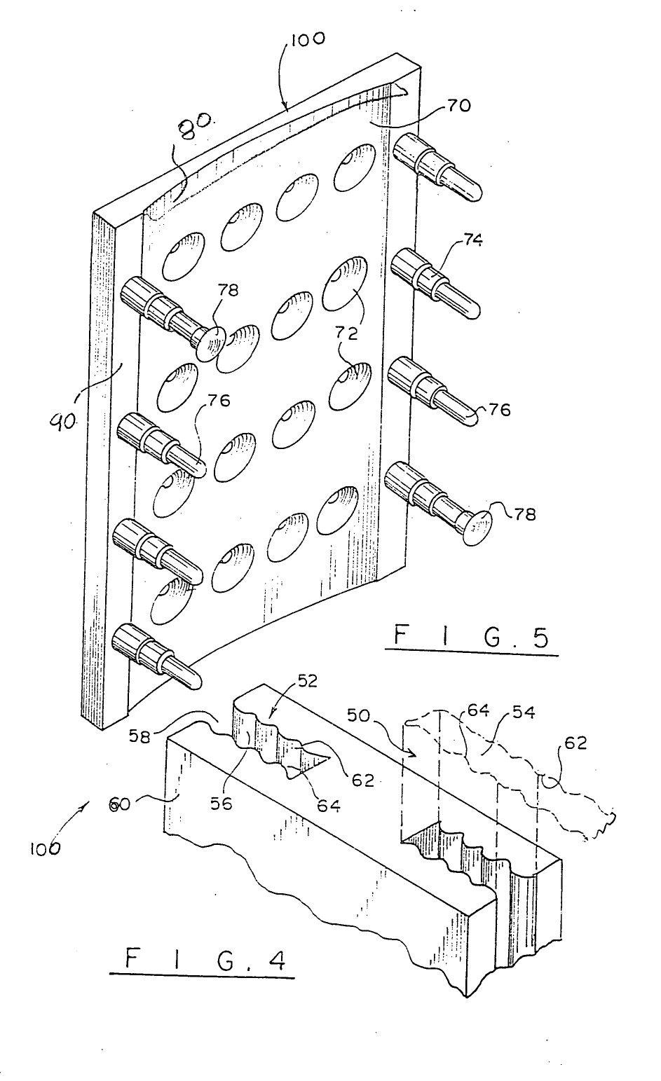

A further modification of the adjustable calming unit 100 is illustrated in FIG. 4 and includes rib-like formations 50 formed on a tongue 54 of width-modifying components and meshing with corresponding formations 52, which are provided on inner flanks 56 of a groove 58 formed on a panel 60. In use, troughs 62, defined by adjacent ribs 64 of either one of the displaceable elements, each are dimensioned to frictionally engage ribs 64 of the other displaceable element. In contrast to the embodiment shown in FIG. 2, the rib-like formations 50 and 52 of FIG. 4 may provide a variable width, since the engagement between the main panel and any additional component can be provided not by the entire tongue and groove, but by portions thereof. While the above discussion relates to the width of the calming unit 100, it is clear that the same relates to the additional components attachable to the top and/or bottom of the main panel to modify the height of the latter. Furthermore, the calming unit 100 is preferably formed by extrusion and made from relatively resilient material, such as plastic or rubber or even sheet metal. As a result, the dimension of the groove 58 may be slightly smaller than the width of the tongue 54, which, upon its insertion into the groove, spreads the flanks 56 away from one another. Due to the resiliency of the material, the flanks 56 tend to compress toward one another and reliably engage the tongue. Note that the configuration of the tongue and groove assembly can be reversed so that the grooves would be formed on the components and the tongues on the panel 60 of the inventive calming unit.

Referring to FIG. 5, in accordance with still another aspect of the invention, the inventive calming unit 100 is configured for use by an operator trying to calm and retain an animal, which is located beyond a cage or kennel. Typically, the operator tries to push the animal towards any surface effectively limiting the degrees of freedom for the animal. Having the concave cross-section of an outer side 70 of a panel 90 and an arrangement of holes 72 affords the animal with all of the advantages discussed above with respect to the case or kennel. However, of course, it is easy to escape the calming unit of FIGS. 1 and 1A-4 if the latter is used in an open space. To reduce such a possibility, the panel 90 has a multiplicity of arms 74 arranged in parallel rows along opposite vertical sides (and/or, if required, along opposite horizontal sides) of the panel 90 and limiting lateral displacement of the animal. Advantageously, the arms 74 are telescopic. To prevent the animal from popping over the panel 10′ and 90 (FIGS. 1 and 5), the latter is provided with a lip or collar 80 located on the top of the outer side 16 (FIG. 1). Given only as an example, the lip 80 can be about 2″ for a cat, whereas for a dog, the lip can be about 4″. The length of the arms 74 may be substantial enough to facilitate the process of limiting the animal's motion by establishing contact between the free ends 76 of the arms and any surface towards which the operator is trying to push the animal. In case of the telescopic structure, to reduce the space between the surface and the smooth outer side 70 to the size slightly larger than the size of the animal, the arms 72 would collapse upon pressing their free ends 76 against the surface. At least some of the arms may have free ends each provided with an enlarged pad 78 to establish a reliable contact with the surface.

It will be understood that various modifications may be made to the embodiments disclosed herein. Therefore, the above description should not be construed as limiting the scope of the invention, but merely as exemplifications of the preferred embodiments. Those skilled in the art will envision other modifications within the scope and spirit of the claims appended hereto.

1. A portable calming unit for an animal comprising a perforated panel configured to allow an operator to both gain control of, and treat, the animal.

2. The portable calming unit of claim 1, wherein the perforated panel is shaped and dimensioned to be removably inserted within a cage or kennel containing the animal and displaceable therein to decrease a space between a smooth outer side of the perforated panel and a side of the cage or kennel to a size of the animal, the perforated panel having an outer peripheral edge configured to conform to an inner surface of the cage or kennel so that the outer peripheral edge and the inner surface of the cage or kennel are juxtaposed to form peripheral clearances configured to prevent the animal from escaping the cage or the kennel during displacement of the perforated panel.

3. The portable calming unit of the claim 2, wherein the perforated panel has a smooth inner side opposite the smooth outer side and provided with at least one handle which is configured to give an operator maneuverability to easily rock the animal back into the side of the cage or kennel, the smooth inner and outer sides of the perforated panel are traversed by a multiplicity of openings.

4. The portable calming unit of claim 3, wherein the multiplicity of openings each have a cross-section selected from the group consisting of circular, oval and polygonal and a combination thereof.

5. The portable calming unit of claim 3, wherein the multiplicity of openings each tapers from one of the smooth inner and outer sides of the perforated panel to the opposite one.

6. The portable calming unit of claim 2, further comprising at least one width-modifying component couplable to a side of the perforated panel along the outer peripheral edge thereof to modify a width of the perforated panel.

7. The portable calming unit of claim 6, further comprising at least one height-modifying component couplable to a top or bottom of the perforated panel along the outer peripheral edge thereof, and an engaging assembly located between and configured to removably couple the perforated panel to the width- and height-modifying components.

8. The portable calming unit of claim 7, wherein the engaging assembly includes a groove and a tongue each associated with a respective one of the perforated panel and the width- and height-modifying components, the groove and the tongue being configured to slidingly engage one another upon displacement of the perforated panel and each of the width- and height-modifying components relative to one another.

9. The portable calming unit of claim 8, wherein the groove and tongue each have a respective dovetail cross-section.

10. The portable calming unit of claim 8, wherein the groove and the tongue each is provided with a respective plurality of alternating ribs and troughs formed so that each of the troughs is shaped and dimensioned to slidingly receive a respective rib during displacement of the perforated panel and the width- and height-modifying components to selectively adjust dimensions of the perforated panel.

11. The portable calming unit of claim 8, further comprising additional width- and height-modifying components.

12. The portable calming unit of claim 1, wherein the perforated panel is configured with a pair of opposite longitudinal edges each provided with a row of spaced apart telescopic arms extending from an outer side thereof to reduce a space between the outer side and a support surface, against which free ends of the telescopic arms are pressed against, to a size approximating a size of the animal.

13. The portable claming unit of claim 12, wherein the perforated panel has opposite edges extending transversely to the longitudinal edges and each provided with a respective row of the telescopic arms.

14. The portable calming unit of claim 11, wherein the perforated panel had an outer side of the perforated panel is inwardly concave.

15. The portable calming unit of claim 11, wherein the perforated panel has an inner side opposite to the outer side and provided with a pair of handles.

16. The portable calming unit of claim 1, wherein the perforated panel has an outer side facing the animal and provided with a lip, which is coupled to a top of the outer side and configured to prevent the animal from popping up over the perforated panel.

17. A kit comprising a plurality of variously dimensioned calming units each having a respective perforated panel, which is configured to allow an operator to selectively use a respective one of the perforated panels to gain control of, and treat, an animal having a size associated with the respective perforated panel.

18. The kit of claim 17, wherein the perforated panels each have a respective outer side facing the animal and provided with a lip configured to prevent the animal to pop up over an upper edge of the outer side.

19. The kit of claim 18, wherein the perforated panels each have a respective inner side opposite the outer side and provided with a plurality of handles configured to be held by an operator.

20. The kit of claim 17, wherein the perforated panels each have a plurality of openings configured to allow an operator to administer a procedure upon gaining control over the animal
